(19) United States
(12) Patent Application Publication
(10) Pub. No.: US 2025/0054403 A1
(43) Pub. Date: Feb. 13, 2025

(54) SOFTWARE ARCHITECTURE FOR A LEARNING ENVIRONMENT

(71) Applicant: MetaTink LLC, Englewood, CO (US)

(72) Inventors: Daniel Matthew Likarish, Englewood, CO (US); Mike B. Prasad, Castle Rock, CO (US); Todd A. Edmands, Lafayette, CO (US); Vincent Garramone, St. Paul, MN (US); Ricardo Orozco Cisneros, Lakewood, CO (US); Steven P. Fulton, Colorado Springs, CO (US); Roy C. Montenegro, Aurora, CO (US); Erik Lowell Moore, Lacey, WA (US)

(21) Appl. No.: 18/749,715

(22) Filed: Jun. 21, 2024

Related U.S. Application Data
(60) Provisional application No. 63/532,253, filed on Aug. 11, 2023.

(51) Int. Cl. G09B 5/02; G06F 3/04842; G06F 11/34

(52) U.S. Cl. CPC G09B 5/02; G06F 3/04842; G06F 11/3438

(57) ABSTRACT

A learning environment presents, at a first skill level, first content of a first learning requirement to a learner via a user interface on a client device. The learning environment detects behavior of the learner selecting assistive content during interaction with the first content and determines a proficiency of the learner at a decision point of the first learning requirement. The learning environment determines a path directive based on the behavior, the proficiency, and a learner history, where the path directive defines a direction of a next step in the learning path for the learner. The learning environment determines a next content and a next skill level based on the path directive and presents the next content at the next skill level to the learner via the user interface.

### RELATED APPLICATION

This application claim priority to U.S. Patent Application Ser. No. 63/532,253, filed Aug. 11, 2023, titled “Software Architecture Learning Environment,” which is incorporated herein by reference in its entirety.

### BACKGROUND

Teaching software typically test knowledge retention of a learner during or after presentation of teaching materials. After testing, the teaching software selects a next set of training materials. The teaching software only reacts to test results and is unable to adapt on-the-fly as the learner is interacting.

### SUMMARY

One aspect of the present embodiments includes the realization that people learn at different rates and retain different amounts of knowledge. A learner participates (navigates) in a learning activity based on learning objectives to increase their education. In the prior art, the learner is given a test after the lesson to measure the amount of retained knowledge. However, post-lesson testing, or even mid-lesson testing, does not fully evaluate the needs of the learner. This problem is amplified in computer-based learning environments because the computer-based learning environment has limited ability to interact with the learner and modify its content based thereon. The present embodiments solve this problem by providing a learning environment that monitors the amount of optional assistive content (e.g., hints, recaps, definitions, etc.) requested by the learner or provided by the learning environment throughout the lesson to measure the needs of the learner and to dynamically adapt the lesson content based on the learner's needs. Advantageously, the learner is not interrupted during the lesson for evaluation, and the learning environment automatically adapts the lesson content based on the learner's needs (and not the learner's test performance after the lesson is completed). The learning environment changes the lesson content dynamically to keep the learner challenged and engaged. This increases and maintains the performance of the learner.

In embodiments herein, the learning environment may use the learner's selection of optional assistive content or the learning environment's recognition of learner need during the lesson as an indicator of a challenge gradient perceived by the learner. Accordingly, the learner automatically adjusts the challenge level presented by the lesson content in real time by requesting the optional assistive content. For example, access to the optional assistive content within the lesson is provided by links and/or other learner interactions (e.g., mouse hovering and/or other digital means such as a verbal, AI request, etc.) that provides the learner with immediate support when the challenge of the current lesson content is perceived beyond immediate reach. Alternatively, the learning environment may provide assistive content automatically if learner behavior indicates lack of understanding (e.g., by typing the wrong command multiple times during an interactive lesson). Accordingly, the learning environment may change the learning path for the learner at multiple points throughout the lesson to achieve a greater success level as compared to prior art learning strategies.

In embodiments herein, the learning environment determines learner engagement in particular content by measuring their success in learning challenges and evaluating the learner's requests for optional assistive content. This sensitivity to learner engagement and awareness of the learner's use of optional assistive content allows the learning environment to adapt the content and learning path to improve learner engagement in an adaptive fashion.

In embodiments herein, the learning environment may incorporate advances in learning theory and practice by providing an innovative, immersive, and adaptive experience to create a self-aware learning style for the learner. The learning environment implements processes and algorithms that use analytics to facilitate the new learning environment for the learner.

In certain embodiments herein, the learning environment uses a decision process to offer a unique way of generating customized paths through learning material (e.g., content and sequences thereof) that change course decisions of success and failure into refined decisions of appropriateness of engagement, challenge, and content sequence. Accordingly, the learning environment guides the learner to more swiftly progress through the learning material and achieve a higher level of engagement as they meet the learning objectives.

In certain embodiments, the techniques described herein relate to a method for adapting a learning path of a learner through a course, including: detecting behavior of the learner selecting, via interaction with a client device, assistive content during interaction with first content, of a first learning requirement of the course, displayed in a user interface on the client device; determining a proficiency of the learner at a decision point of the first learning requirement; determining a path directive based on the behavior, the proficiency, and a learner history, the path directive defining a direction of a next step in the learning path for the learner; determining a next content and a next skill level based on the path directive; and presenting the next content at the next skill level to the learner.

In certain embodiments, the techniques described herein relate to a learning environment for adapting a learning path of a learner through a course, including: a processor; a memory communicatively coupled with the processor and storing machine-readable instructions that, when executed by the processor, cause the processor to: present first content, of a first learning requirement, to the learner at a first skill level within a user interface on a client device; detect behavior of the learner selecting assistive content during interaction with the first content within the user interface; determine a proficiency of the learner at a decision point of the first learning requirement; determine a path directive based on the behavior, the proficiency, and a learner history, the path directive defining a direction of a next step in the learning path for the learner; determine a next content and a next skill level based on the path directive; and present the next content at the next skill level to the learner within the user interface.

### BRIEF DESCRIPTION OF THE FIGURES

FIG. 1 is a schematic block diagram showing one example learning environment with an adaptive content engine, in embodiments.

FIG. 2 is a block diagram illustrating example learning paths through the course of FIG. 1, in embodiments.

FIG. 3 is a schematic diagram illustrating example transition paths between the content of FIG. 1, in embodiments.

FIG. 4 is a schematic illustrating example operation of the adaptive content engine of FIG. 1, in embodiments.

FIG. 5 is an interaction graph illustrating example measurement of assistive content and learning challenges during the lesson of FIG. 1, in embodiments.

FIG. 6 is a screen shot illustrating a first example display of the lesson on the client device of FIG. 1, in embodiments.

FIG. 7 is a schematic showing progress of the learner through the course when the learner is an advanced learner, in embodiments.

FIGS. 8 and 9 are similar to FIGS. 6 and 7, except that the learner is a novice learner, in embodiments.

FIGS. 10 and 11 follow the example of FIGS. 6 and 7, where the learner is an advanced learner.

FIGS. 12 and 13 follow the example of FIGS. 8 and 9 where the learner is a novice learner.

FIGS. 14 and 15 follow the example of FIGS. 6, 7, 10, and 11, where the learner is an advanced learner.

FIGS. 16 and 17 follow the example of FIGS. 8, 9, 12 and 14, where the learner is a novice learner.

FIG. 18 shows one example report of progress made by the learner through the course, in embodiments.

FIG. 19 is a data table illustrating example internal functionality of the adaptive content engine of FIG. 1 to track interaction of the learner with the content of the course to determine the path directive, in embodiments.

FIG. 20 shows one example graph illustrating progress made by the learner through each learning objective of the course, in embodiments.

FIG. 21 is an interaction graph further illustrating progress of the learner through learning activities of the content of FIG. 1, in embodiments.

### DETAILED DESCRIPTION OF THE EMBODIMENTS

### Definitions

Course-A course is a series of learning activities supporting a collection of learning outcomes. For example, a course for a line cook may include everything from safety, tool selection, to clean-up.

Primary content—The main content in the learning objects that does not change based on learner behavior. For example, specific text, videos, or interactive material that all learners experience.

Dynamic Assistive Content—content (e.g., text, videos, or interactive material) that is presented to the learner based on learner behavior and behavior history.

Skill level—a quantification of a learner's ability to learn (e.g., low/novice, average, high/advanced).

Capability Level—the individual experience constructed to cover a learning objective for learners with a specific capability.

Proficiency Level—the rating of learners' performance going through a particular capability level of a learning objective.

Learning Objective-a set of content and decision points on a specific topic as created by an instructional designer, having primary content, dynamic assistive content, and decision points that are used to adapt to the learner's behavior.

Learning Path-a dynamic path through a sequence of learning objectives, where the learning path is dynamically changed to follow content at an appropriate skill level and immediate topical needs of the learner based on the learner's selection of dynamic assistive content and proficiency in the decision points. There are three general categories of learning path choice: Remedial Path that pulls additional supportive content outside the Learning Objective; the Standard Path, that selects the next learning Activity in a Learning Objective and the Accelerated Path that skips content identified as of sufficient Proficiency demonstrated in the Learner's History.

Learning Activity-A Learning Activity is the set of content along the progression of predefined content within a Learning Objective for a particular capability level that ends in a decision point. The learning activity may include primary content, assistive content, and the decision point.

Learner—The Learner participates (navigates) in a learning activity based on learning objectives to increase their education.

### Example Learning Environment

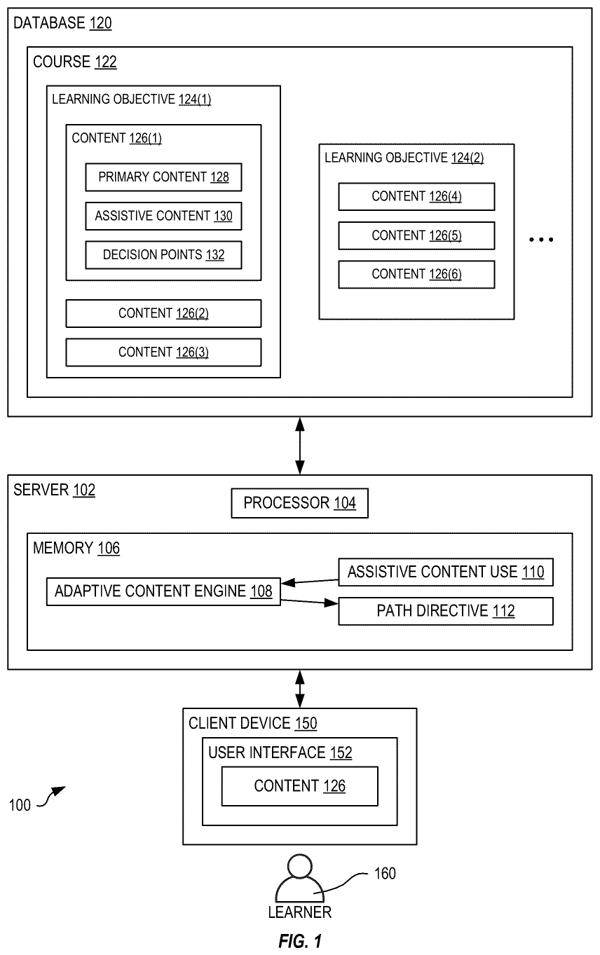

FIG. 1 is a schematic block diagram showing one example learning environment 100 that includes a server 102 with an adaptive content engine 108 that communicates with a client device 150 to direct a learner 160 along a learning path, in embodiments. Learning environment 100 may be implemented on various service architectures including: Internet cloud (SAAS), client/server, standalone laptop, virtual hardware, and so on, without departing from the scope hereof. Adaptive content engine 108 may include machine-readable instructions, stored in memory 106 that are executable by processor 104 to implement functionality described herein.

Server 102 includes at least one processor 104 and a memory 106 communicatively coupled with processor 104 and storing adaptive content engine 108 as machine-readable instructions that when executed by processor 104 cause server 102 to implement the functionality described herein. Memory 106 may include volatile memory, non-volatile memory, removable media, and so on. A database 120 stores a sequence of learning objectives 124(1) and 124(2) that form a course 122. Although shown separate from server 102, database 120 may be stored in memory 106 without departing from the scope hereof. Course 122 is shown with two learning objectives 124(1) and 124(2) for clarity of illustration; however, course 122 may have more or fewer learning objectives 124 without departing from the scope hereof.

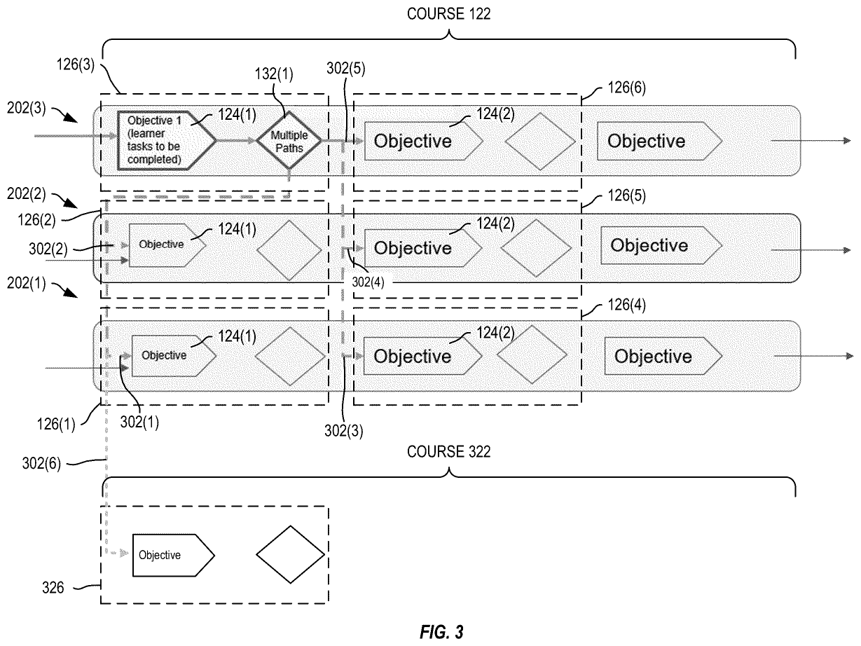

Each learning objective 124 has a plurality of learning objective content 126 for teaching the learning objective at different skill levels. For example, learning objective 124(1) includes content 126(1) for use when learner 160 is of a low skill level, content 126(2) is uses when learner 160 is of an average skill level, and content 126(3) is used use when learner 160 is of a high skill level. Although shown with content 126 at three skill levels, more or fewer skill levels may be implemented without departing from the scope hereof. As described in detail below, a learning path through course 122 may be continuously adapted and may not be limited to a single direction (up and down) as learner 160 works through course 122. At each decision point within course 122, the learning path may have multiple options (e.g., see FIG. 3) based on detected competency of learner 160. For example, the learning path may (a) skip a next learning objective, (b) move to an area of prerequisite deficiency in another area to gap fill, and/or (c) adjust within the learning objective. Further, the learning path may include content from a different course 122 where adaptive content engine 108 determines that learner 160 is lacking in a required proficiency provided by that course. Adaptive content engine 108 uses the learner history (e.g., historical proficiency scores, past performance, etc. of learner 160) to determine the learning path for learner 160 to complete course 122, taking into account selection of assistive content 130 by learner 160.

Adaptive content engine 108 operates to deliver the appropriate content 126 to client device 150 for output to learner 160 within a user interface 152 for example. Content 126 may include primary content 128 that is not adapted and automatically provided to learner 160), assistive content 130 that is not automatically provided to learner 160, but may be invoked interactively by the learner within learning environment 100, and decision points 132 that represents points within content 126 where adaptive content engine 108 may changes the learning path through course 122 for learner 160. That is, assistive content 130 may remain hidden until selected or otherwise invoked by learner 160. Assistive content 130 represents additional information, such as one or more of hints, recaps, definitions, etc., that may be requested by learner 160 to aid in understanding content 126. For example, assistive content 130 may be invoked when learner 160 uses an input device to select a link (e.g., a URL) within content 126, or when learner 160 hovers a mouse pointer over a particular area (e.g., highlighted text) within content 126. Use of assistive content 130 indicates that learner 160 needs additional material beyond content 126 to comprehend content 126. Further, the more assistive content 130 selected by learner 160, the greater the challenge perceived by learner 160 in understanding content 126, which may indicate learner 160 has a lower skill level than that of the current content 126. Adaptive content engine 108 monitors interaction of learner 160 with content 126 and determines assistive content use 110 by learner 160. For example, adaptive content engine 108 detects interaction and input indicative of learner 160 selecting a link within content 126 to invoke assistive content 130 and detects assistive content 130 being invoked when learner 160 hovers the mouse over particular areas to invoke assistive content 130. In certain embodiments, assistive content use 110 is a data structure defining use of assistive content 130 by learner 160 within current content 126 assistive content 130.

Adaptive content engine 108 determines a path directive 112 for learner 160 based on assistive content use 110 and other characteristics of learner 160. That is, based on learner 160 selecting, or not selecting, assistive content 130 within current content 126 and historical proficiency scores of learner 160, adaptive content engine 108 determines path directive 112, which is indicative of the challenge perceived by learner 160 with content 126. Path directive 112 is for example a multi-dimensional data structure that is based on topical and difficulty specificity of selected assistive content 130 that is evaluated against the current content 126 and course 122 overall to determine the challenge presented to learner 160 by the current learning path through course 122. Accordingly, path directive 112 effectively defines certain characteristics of learner 160 that may be used to steer the learning path for learner 160. Particularly, path directive 112 is more than a single value indicative of perceived difficulty, and may evaluate and/or define multiple directions for the learning path within course 122 that are more or less challenging to learner 160. Path directive 112 may steer the learning path to provide content to fill identified topical gaps (e.g., using one or both of internal course information and external course information), to skip content of course 122 where learner 160 demonstrates understanding is known, and to provide a remedial path where learner 160 indicates that additional topical support is needed. For example, adaptive content engine 108 may maintain running topical proficiency scores for learner 160 that are used to determine path directive 112, and thereby the learning path, for learner 160 through course 122. Adaptive content engine 108 may use other characteristics of monitored interaction of learner 160 with content 126 to determine path directive 112.

Adaptive content engine 108 effectively evaluates a skill level of learner 160 based on the learner's interaction with content 126, and particularly the learner's use of assistive content 130 during the current content. That is, path directive 112 may effectively define the skill level of learner 160 relative to content 126 and thereby direct the learning path through course 122. In certain embodiments, path directive 112 defines one of: higher-skill, same-skill, and lower-skill. Higher-skill indicates that the determined skill level of learner 160 is above the skill level of current content 126 and results in path directive 112 directing the learning path towards a higher skill level. Same-skill indicates that the determined skill level of learner 160 is the same as the skill level of current content 126 and results in path directive 112 directing the learning path towards next content 126 at the same skill level. Lower-skill indicates that the determined skill level of learner 160 is below the skill level of current content 126 and results in path directive 112 directing the learning path towards content 126 at a lower skill level.

Adaptive content engine 108 autonomously adapts a learning path followed by learner 160 through course 122 based on path directive 112 without requiring learner 160 to take a test, or requiring the learner to pause their learning. Advantageously, by adjusting the learning path through course 122 for learner 160, adaptive content engine 108 presents a next lesson at an appropriate skill level to allow learner 160 to achieve greater success as compared to prior art learning strategies that do not adapt, or that require post course evaluation of the learner (e.g., post learning tests). Further, as compared to learning from books, where the content is not adaptable and therefore includes assistive content whether needed or not, resulting in a learner of advanced skill levels reading and skipping through unnecessary content.

In one example of operation, learner 160 demonstrates advanced response to a challenge without using assistive content 130, such as demonstrating an advanced knife technique by selecting a serrated knife for cutting newly baked sub bread. Since learner 160 did not select assistive content 130 on knife selection, the learning path for learner 160 automatically skips a later section of course 122 on knife selection (which would be included by default). Accordingly, the learning path for learner 160 through course 122 is shorter, saving the learner time, and keeping the challenge level for learner 160 at a level such that learner 160 stays engaged in course 122 instead of becoming bored as may occur when repeating content already known. Advantageously, adaptive content engine 108 maintains a higher efficiency of progress of learner 160 through the material of course 122 without learner 160 being rushed.

In another operational example, where learner 160 is learning baseball and receives coaching in a lesson on curve balls, learner 160 may be frustrated as they miss curve balls from a pitching machine. As learner works through coaching on posture, learner 160 self-selects assistive content to find corrections that improve performance and automatically skips content of course 122 where performance is demonstrated (like grip, swing, pivot, timing, bat speed, etc.) without the use of available assistive content. Advantageously, adaptive content engine 108 removes the highly repetitive experience of working to improve without adaptation of the challenge based on selection of assistive feedback.

Adaptive content engine 108 presents primary content 128 to learner 160 (e.g., always presented to all learners) and generates assistive content 130 as needed by learner 160 or as selected by learner 160. Adaptive content engine 108 tracks interaction of learner 160 with content 126 to determine path directive 112.

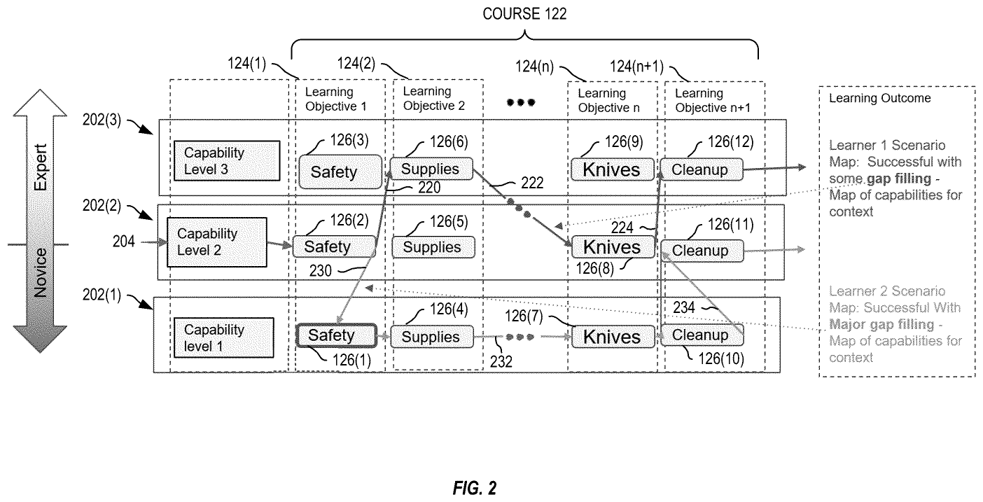

FIG. 2 is a block diagram illustrating example learning paths through course 122 of FIG. 1, in embodiments. In the examples herein, course 122 and its content 126 relate to training a line cook in a fast food restaurant; however, learning environment 100 may implement courses 122 of any length and any content without departing from the scope hereof.

In the example of FIG. 2, course 122 is shown with learning objectives 124(1)-124(n+1), where each learning objective 124 has content 126 at three different skill levels 202; low-skill level 202(1), average-skill level 202(2), and high-skill level 202(3). However, course 122 may be more or fewer learning objectives 124, and more or fewer three different skill levels 202, without departing from the scope hereof. Learning objective 124(1) has content 126(1)-126(3), learning objective 124(2) has content 126(4)-126(6), learning objective 124(n) has content 126(7)-126(9), and learning objective 124(n+1) has content 126(10)-126(12), where content 126(1), 126(4), 126(7) and 126(10) are at low-skill level 202(1), content 126(2), 126(5), 126(8) and 126(11) are at average-skill level 202(2), and content 126(3), 126(6), 126(9) and 126(11) are at high-skill level 202(3).

In these examples, learner 160 is assumed (or evaluated) to be of average skill and starts 204 at average-skill level 202(2) with content 126(2) of learning objective 124(1) (e.g., safety). Adaptive content engine 108 monitors interactions of learner 160 during content 126(2) to determine path directive 112, and then selects a subsequent content 126 for learner 160 based on the current content 126 and the determined path directive 112. Further, it is noted that the learning path for learner 160 is dynamic where adaptive content engine 108 generates path transitions on the fly based upon path directive 112 determined for learner 160.

In a first learning path example, assistive content 130 is used minimally by learner 160 in content 126(2) and the determined path directive 112 indicates that learner 160 is of higher-skill than average-skill level 202(2) of the current content 126(2), and adaptive content engine 108 generates a path transition 220 from content 126(2) to content 126(6) at high-skill level 202(3) for learning objective 124(2). During content 126(6), or subsequent content not shown, learner 160 uses more assistive content 130 and adaptive content engine 108 determines a path directive 112 of lower-skill and generates a path transition 222 to content 126(8) at average-skill level 202(2) within learning objective 124(n). However, during content 126(8), learner 160 exhibits greater skill and no significant use of assistive content 130, whereby adaptive content engine 108 determines path directive 112 as higher-skill and generates a path transition 224 from content 126(8) to content 126(12) at high-skill level 202(3) of learning objective 124(n+1). Accordingly, the learning path, defined by path transitions 220, 222, and 224, adapts to meet the needs of learner 160.

In a second learning path example, assistive content 130 is used extensively (e.g., assistive content use 110 causes path directive 112 to indicate particular deficiencies of learner 160 that require “gap filling” in certain areas and a general need to reduce the difficulty of the content assistive content 130) by learner 160 in content 126(2) and the determined path directive 112 is lower-skill, indicating that learner 160 has a lower skill level than average-skill level 202(2) of the current content 126(2). Further, learner 160 did not meet learning objective 124(1). Therefore, adaptive content engine 108 generates a path transition 230 from content 126(2) to content 126(1) at low-skill level 202(1) of learning objective 124(1), such that learner 160 receives additional background information in content 126(1) for learning objective 124(1). Adaptive content engine 108 determines path directive 112 as same-skill during content 126(1) (e.g., path directive 112 does not indicate that learner 160 shows higher-skill than low-skill level 202(1) of content 126(1)), and therefore adaptive content engine 108 selects subsequent content 126(4) at low-skill level 202(1) for learning objective 124(2). Similarly, during content 126(4), and 126(7), adaptive content engine 108 determines path directive 112 as same-skill and learner 160 progresses through course 122 at low-skill level 202(1). During content 126(10), learner 160 uses less assistive content 130 and adaptive content engine 108 determines path directive 112 as higher-skill. However, since learner 160 failed to meet learning objective 124(n+1), adaptive content engine 108 determines a path transition 234 from content 126(7) to content 126(11) at average-skill level 202(2) such that learner 160 may achieve learning objective 124(n+1). Accordingly, the learning path, defined by path transitions 230, 232, and 234, adapts to meet the needs of learner 160, where path directive 112 provides a subtle direction for the learning path based on determined needs to learner 160. Although these examples steer the learning path through content of the same course 122, based on path directive 112, adaptive content engine 108 may also change the learning path to include content from other courses. For example, where path directive 112 indicates a lack of proficiency in a topic that is required by course 122, adaptive content engine 108 may select certain content from a different course for inclusion in the learning path of learner 160.

FIG. 3 is a schematic diagram illustrating example transition paths between content 126 of course 122 of FIG. 1 that may be defined by path directive 112, in embodiments. In this example, content 126(3) is currently being displayed to learner 160 and includes learning objective 124(1) and a decision point 132(1). Data collected for performance assessment includes multiple measurements such as timing of interaction by learner 160 and whether learner 160 chooses assistive content and/or whether learner 160 resolves the challenge on this particular content. Each decision point 132 allows adaptive content engine 108 to divert the learning path based on requests for assistive content and challenge completion success levels of learner 160 for any single module. At decision point 132(1), based on determined path directive 112 and/or completion of learning objective 124(1), adaptive content engine 108 transitions to any one of content 126(1) via a learning path option 302(1), content 126(2) via a learning path option 302(2), content 126(4) via a learning path option 302(3), content 126(5) via a learning path option 302(4), content 126(6) via a learning path option 302(5), and content 326 of a different course 322 via a learning path option 302(6). In certain embodiments, adaptive content engine 108 makes two decisions: (a) whether to advance to the next learning objective 124 based on whether learner 160 completed the current learning objective 124, and (b) which skill level 202 to use based on path directive 112 and the current skill level (e.g., 202(3) in this example). Based on these decisions, adaptive content engine 108 continues with one of content 126(1), 126(2), 126(4), 126(5), 126(6), and 326. Where content 326 is selected from a different course 322, the learning path may revert to appropriate content 126 of course 122 when content 326 is completed by learner 160.

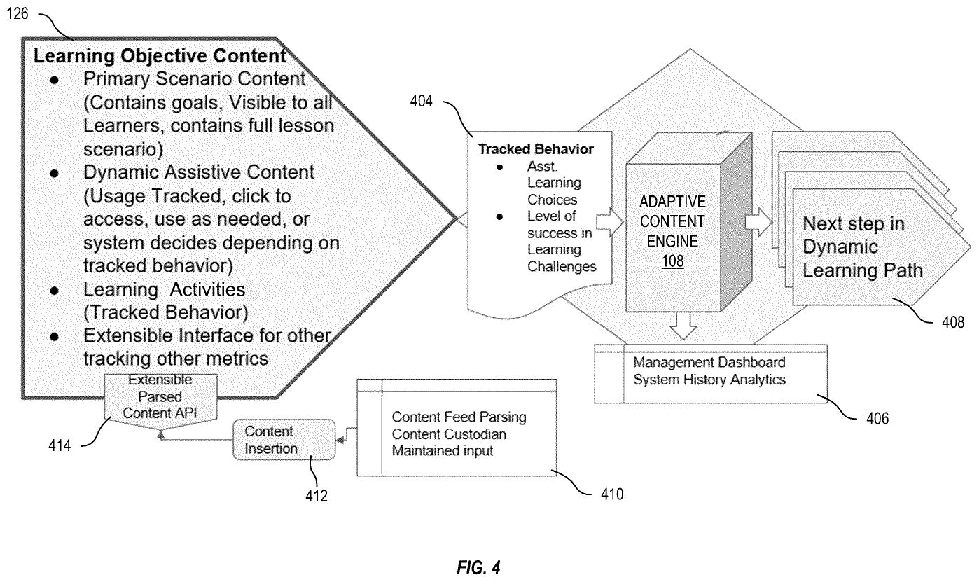

FIG. 4 is a schematic illustrating example operation of adaptive content engine 108 of FIG. 1, in embodiments. Content 126 defines one or more of: primary scenario content, dynamic assistive content, learning challenges, and an extensible interface for tracking other metrics. The primary scenario content contains goals, visible to all learners, and contains full lesson scenarios. Content 126 is created by a designer of course 122 and not format specific. Content 126 may include one or more of video, lab activities, text, images, web links, interactive puzzles, and immersive metaverse scenarios. However, requirements of content 126 include goals, challenges, primary content, assistive content, and learning path direction for particular sets of assistive content selection. Adaptive content engine 108 uses specific formats and values for evaluating use of assistive content 130 (e.g., an identity and corresponding value of the selected assistive content 130) to determine path directive 112 defining a directive (e.g., harder, easier, skip, gap-fill, repeat, stop-and-alert-manager, etc.) for the learning path of learner 160. As learner 160 works through content 126, adaptive content engine 108 may use a decision tree to determine the learning path. The specific requirements for a lesson's next steps are defined by the instructional designer based on expected learning outcomes of a particular course. However, adaptive content engine 108 adapts this standardized content format and modified the learning path as sufficient behavior of learner 160 is captured . . . . As learner 160 interacts with content 126, adaptive content engine 108 receives tracked behavior 404 of the interaction. Tracked behavior 404 may include assistive learning choices (e.g., detection of the mouse hovering over highlighted text to invoke hints, or selection of links to invoke assistive content 130) and a level of success in learning challenges within content 126. Adaptive content engine 108 processes tracked behavior 404 and generates analytical information 406 (also known as a management dashboard) and a next step 408 (e.g., a next current content 126) in the learning path for learner 160. Analytical information 406 may be stored in a behavioral history, which is used by adaptive content engine 108 to make decisions on a next step in the learning path. For example, the behavioral history tracks a level of discrete skills of learner 160 that allow adaptive content engine 108 to direct the learning path to modules to improve lacking proficiency of learner 160. The behavioral history may also be used to determine what assistive content is provided to learner 160 without needing learner input (e.g., based on a previously tracked deficiency.).

External content 410 (e.g., resulting from one or more of content feed parsing, content custodian maintained input, etc.) is processed by content insertion tool 412 to generate extensible parsed content 414 that may be used by learning environment 100. Content insertion tool 412 takes external curricula and generates metadata that allows adaptive content engine 108 to track behavior of learner 160 and select the learning path. Particularly, content insertion tool 412 adds metadata that allows adaptive content engine 108 to generate path directive 112 based on use of external content 410 by learner 160.

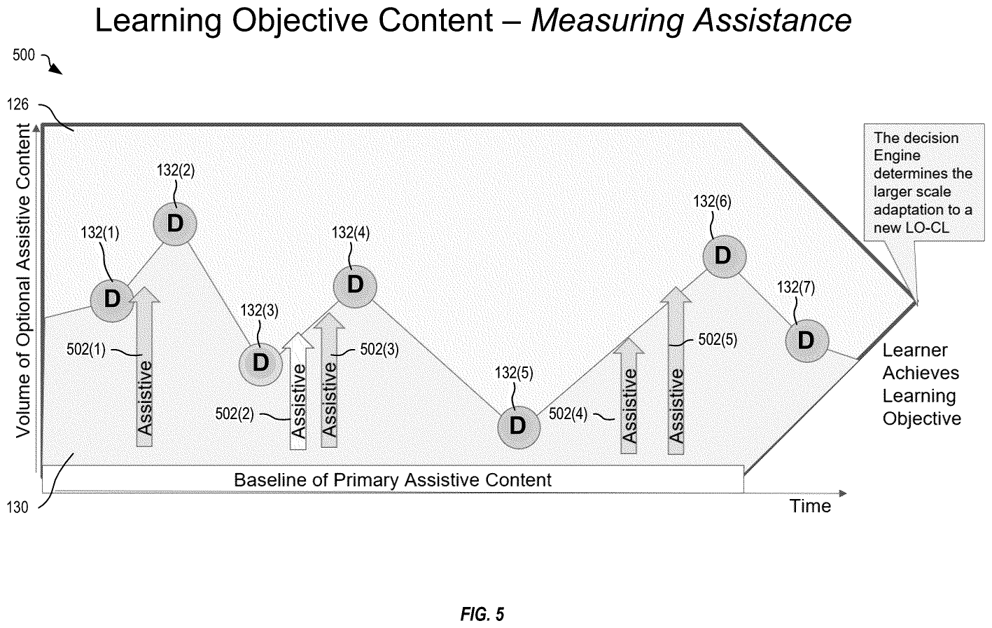

FIG. 5 is an interaction graph 500 illustrating example assistive content 130 and decision points 132 within content 126, in embodiments. Particularly, interaction graph 500 shows a volume, represented by arrows 502, of assistive content 130 used by learner 160 and where learner 160 proficiency is assessed at decision points 132 within content 126. In interaction graph 500, one arrow 502 is shown for each time assistive content 130 is requested and a size of the arrow indicates a volume of the assistive content. In the example of FIG. 5, content 126 includes seven decision points 132(1)-132(7) and five arrows 502(1)-502(5) indicative of five times when learner 160 requested assistive content 130. At the end of current content 126, assessment of learner 160 proficiency at decision points 132 and a quantity of assistive content 130 invoked by learner 160 are evaluated by adaptive content engine 108 and a next current content 126 is selected for learner 160. Learner behavior is assessed at decision points 132 against assess that are presented to learner 160 as part of content 126. Learner 160 may be presented with additional assistive content 130 as an adaptation when behavior of learner 160 in response to decision points 132 indicate the assistive content 130 is needed. Alternatively, assistive content 130 may be available for selection by learner 160, where accessing the assistive content 130 is tracked, as described above. The designer of course 122 may also create paths (e.g., within metadata of course 122 and/or content 126) to incorporate learning objectives from other courses based on the proficiency scores derived from decision points 132.

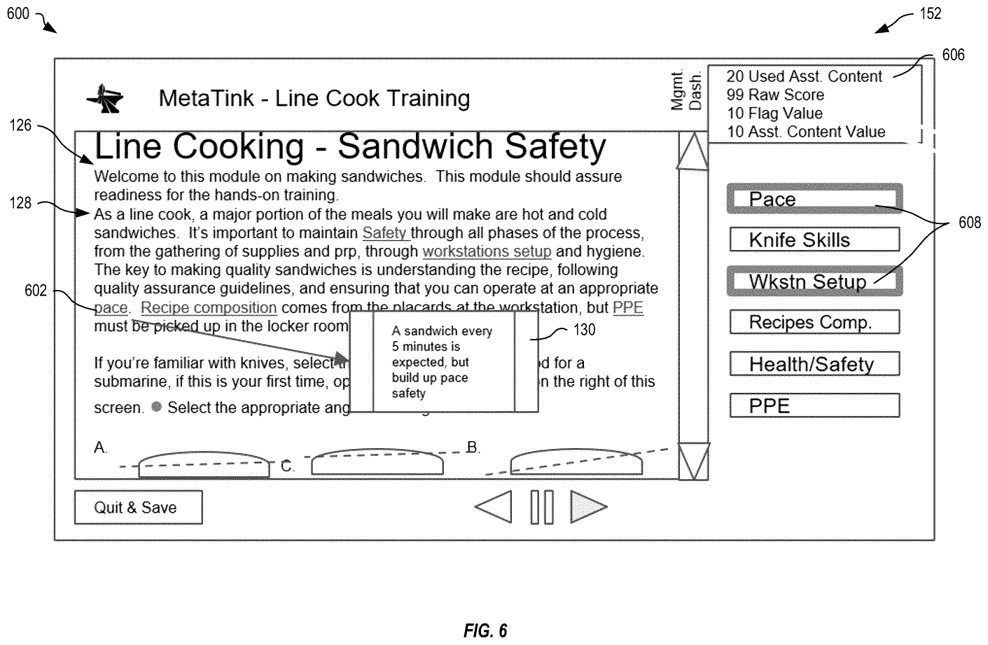

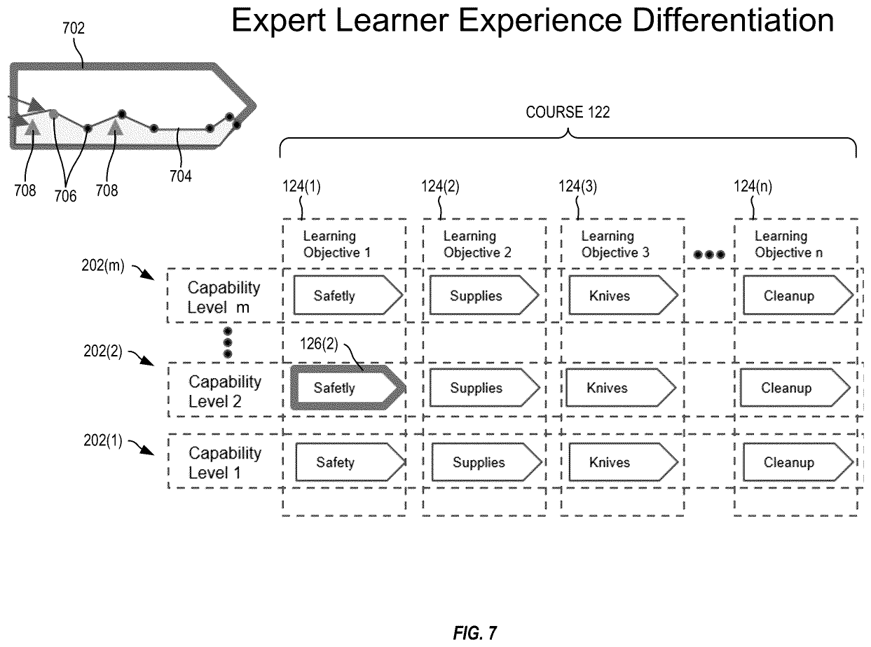

FIG. 6 is a screenshot 600 illustrating a first example display of content 126 on client device 150 of FIG. 1 within user interface 152, in embodiments. FIG. 7 is a schematic showing progress of learner 160 through course 122 when learner 160 is an advanced learner, in embodiments. FIGS. 6 and 7 are best viewed together with the following description.

Screenshot 600 includes a portion of content 126 and includes a hyperlink 602 selected by learner 160 to display assistive content 130 relating to “pace” of making sandwiches. That is, learner 160 has selected hyperlink 602 causing display of assistive content 130 to learn about the appropriate pace, since this was unknown to learner 160. Screenshot 600 also shows analytical information 606 (e.g., analytical information 406, FIG. 4 generated by adaptive content engine 108) derived from interaction of learner 160 with content 126 during learning of current content 126 Analytical information 606 may be presented as a management dashboard with custom views for learner 160 to see progress through course 122, for managers to assess progress of one or more learners through course 122, and may have other roles within learning environment 100. Screenshot 600 also shows example assistive content buttons 608 that allow learner 160 to display more detailed assistive content 130. Although shown as buttons, assistive content buttons 608 may be implemented as other selectable forms, such as hyperlinks, without departing from the scope hereof. FIG. 7 also shows a lesson object 702 corresponding to analytical information 606 for reference and indicating a lesson learning path 704 through content 126(2) for learner 160. In this example, learner 160 completes decision point 132 of content 126(2) without significant use of assistive content 130. Lesson learning path 704 represents the level of rigor of the challenge set by the course designer within content 126(2) with non-variable challenge difficulty values 706. Use of assistive content 130 by learner 160 (or provided by adaptive content engine 108) is indicated by arrows 708. Accordingly, the amount of arrows 708 varies either by selection of assistive content 130 by learner 160 or by an internal function of adaptive content engine 108 that offers more or less assistive content 130 automatically as needed by learner 160.

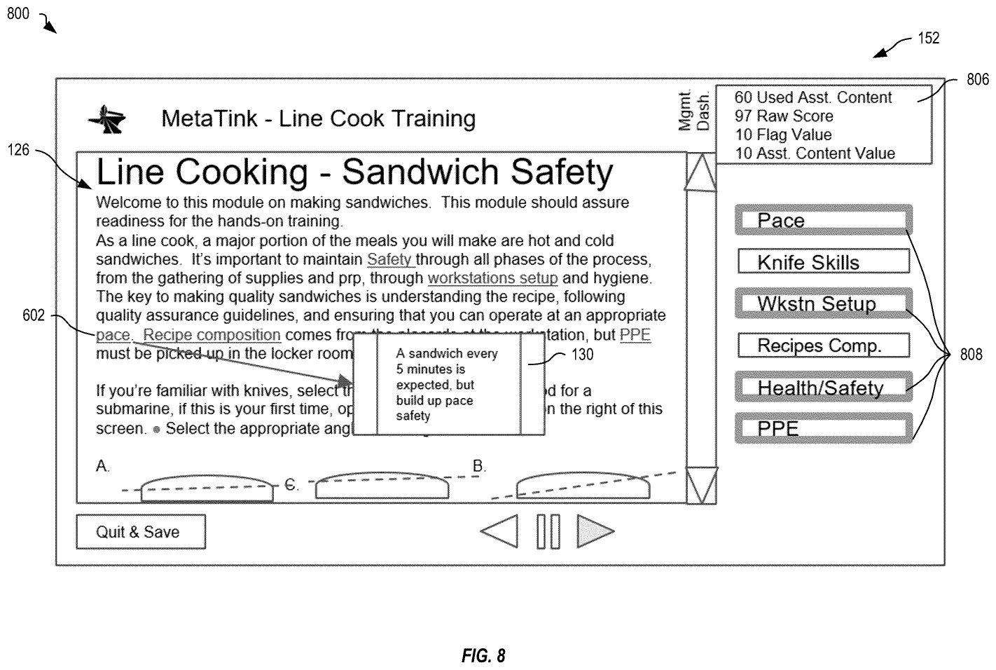

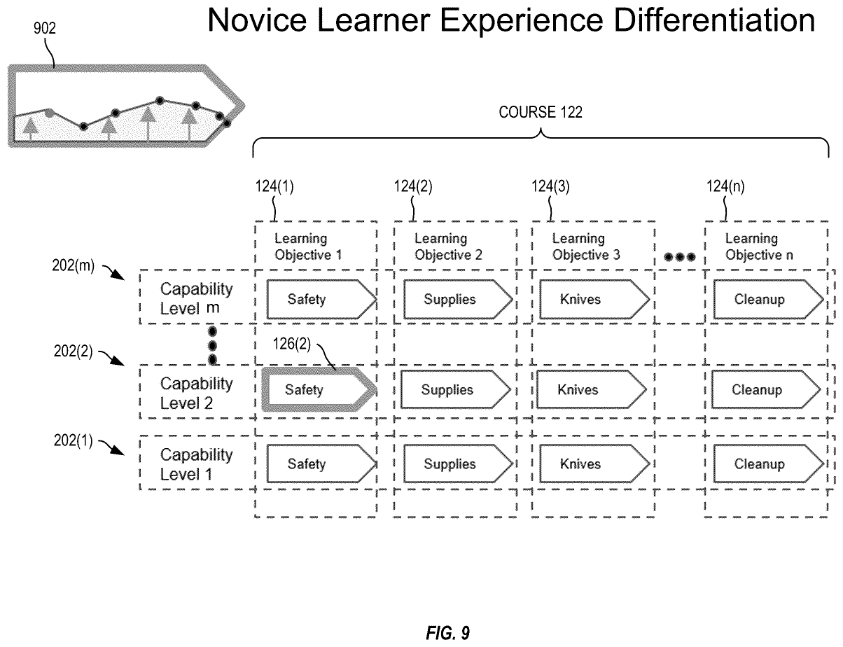

FIGS. 8 and 9 are similar to FIGS. 6 and 7, except that learner 160 is a novice learner, in embodiments. FIGS. 8 and 9 are best viewed together with the following description. In this example, learner 160 has used significantly more assistive content 130, as indicated by analytical information 806. Screenshot 800 also shows assistive content buttons 808 that allow learner 160 to display more detailed assistive content 130. Accordingly, interaction graph 902 identifies gaps in knowledge of learner 160 and measures a skill level of learner 160. Further, adaptive content engine 108 may include sensitivity to learner engagement in certain content. For example, based on assistive content 130 requested by learner 160, adaptive content engine 108 may determine that learner 160 is less knowledgeable about certain topics, such as pace, workstation setup, health and safety, and personal protective equipment (PPE) in this example.

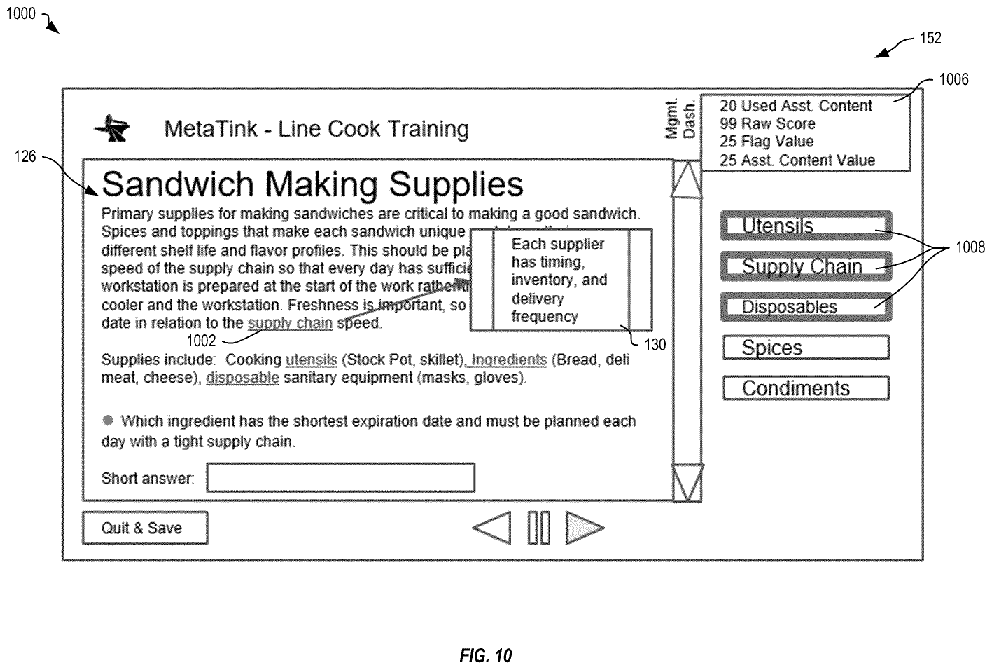

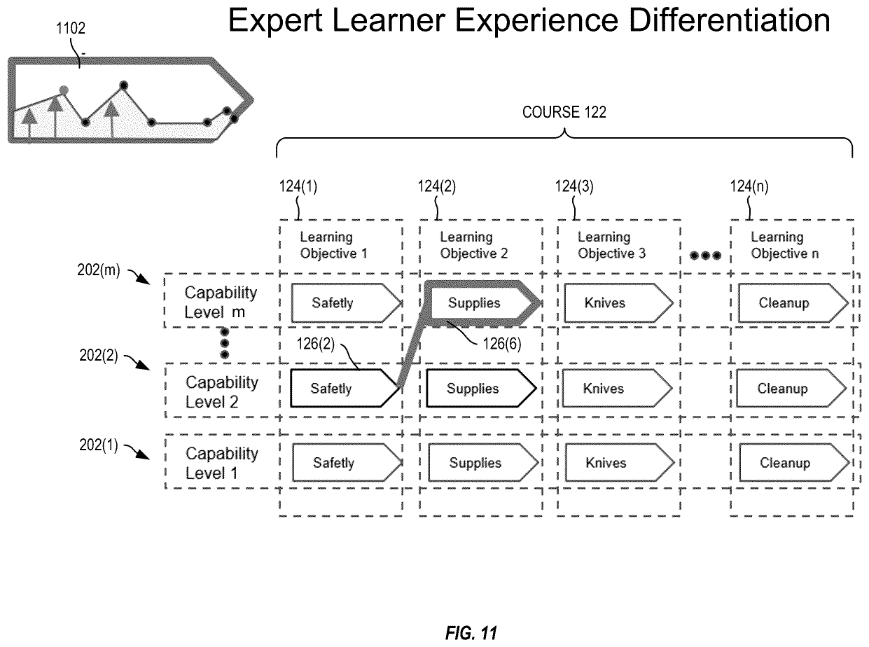

FIGS. 10 and 11 follow the example of FIGS. 6 and 7, where learner 160 is an advanced learner. In this example, learner 160 has selected hyperlink 1002 causing display of assistive content 130 to learn about the supply chain, since this was unknown to learner 160. Accordingly, interaction graph 1102 identifies gaps in knowledge of learner 160 and measures a skill level of learner 160. Since learner 160 completed all decision point 132 of content 126(2) without requesting any significant quantity of assistive content 130 (e.g., available assistive content 130 does not results in path directive 112 indicating changes in the learning path for learner 160), analytical information 1006 and corresponding path directive 112 causes adaptive content engine 108 to select content 126(6) at high-skill level 202(m) to follow content 126(2). Screenshot 1000 also shows assistive content buttons 1008 that allow learner 160 to displays more detailed assistive content 130. An example implementation of the embodiments hercon is provided at the end of this specification.

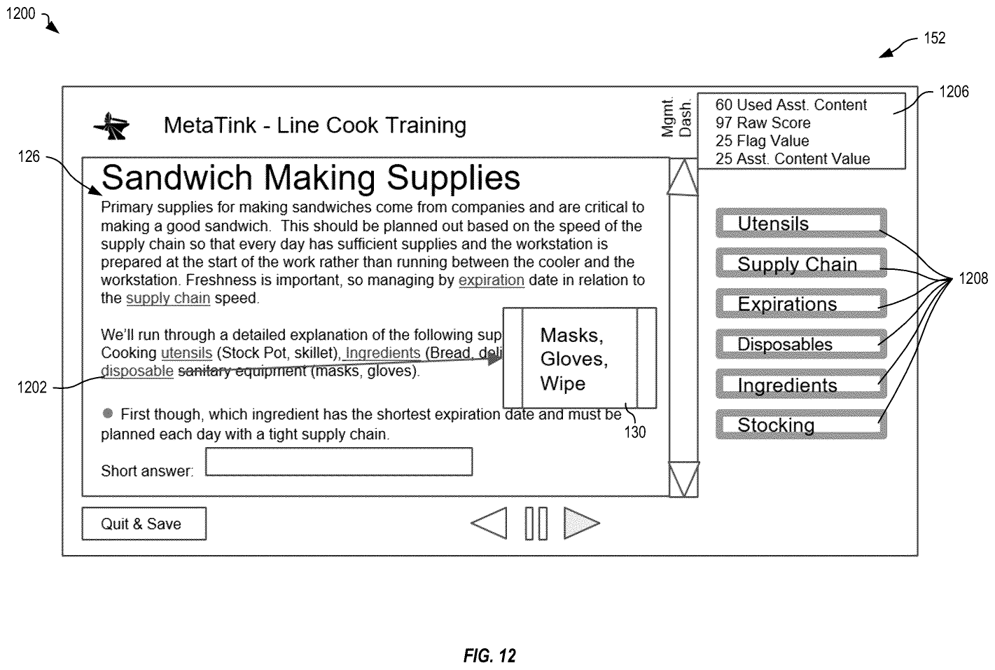

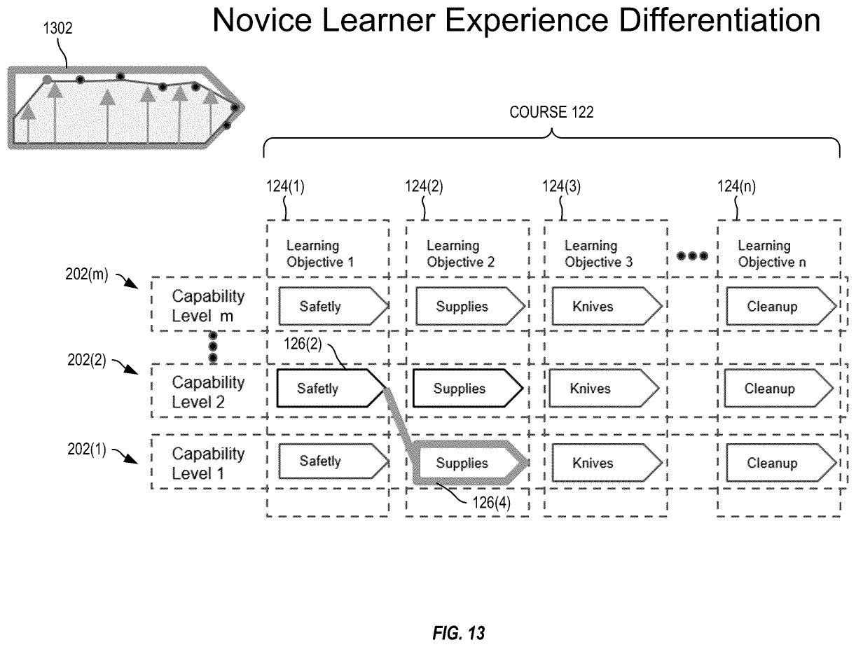

The learning path through course 122 (e.g., between content 126) may have a varying number of routes, some harder and some easier, and may also skip content, change topic, and/or repeat a lesson at a different skill level. Accordingly, adaptive content engine 108 provides both course adaption (e.g., between content 126) and fine adaption (e.g., within each content 126) of the learning path for learner 160. FIGS. 12 and 13 follow the example of FIGS. 8 and 9 where learner 160 is a novice learner. That is, learner 160 has selected hyperlink 1202 causing display of assistive content 130 to learn about disposable equipment, since this was unknown to learner 160. Accordingly, interaction graph 1302 identifies gaps in knowledge of learner 160 and measures a skill level of learner 160. Since learner 160 completed all decision point 132 of content 126(2), but only after requesting a significant quantity of assistive content 130, analytical information 1206 and corresponding path directive 112 causes adaptive content engine 108 to select content 126(4) at low-skill level 202(1) to follow content 126(2). Screenshot 1200 also shows assistive content buttons 1208 that allow learner 160 to displays more detailed assistive content 130.

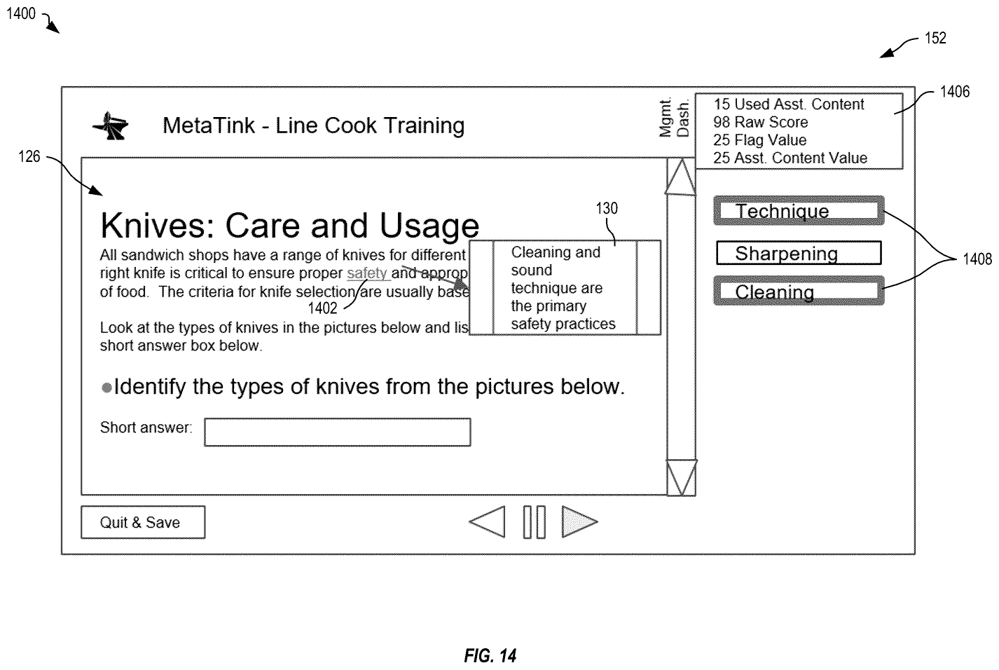

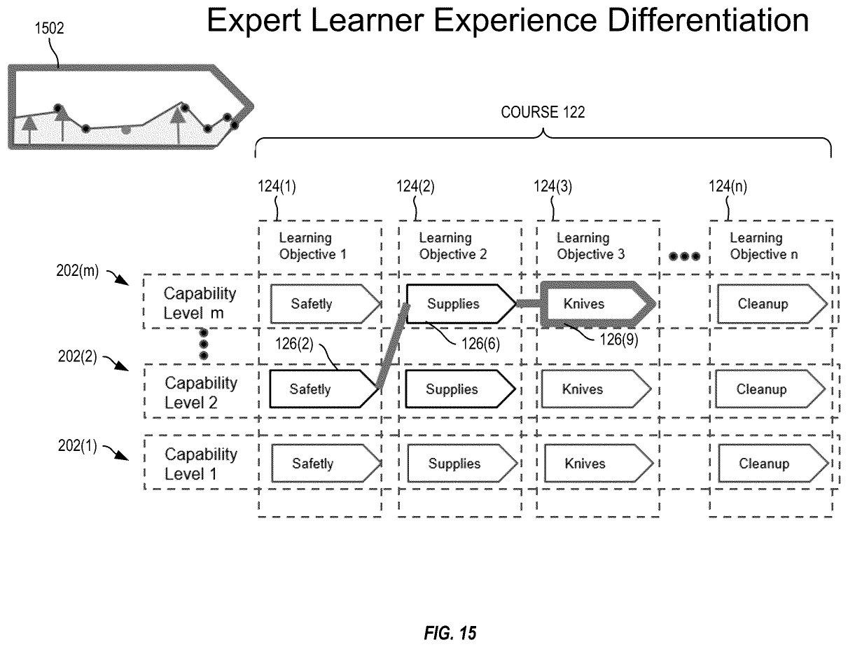

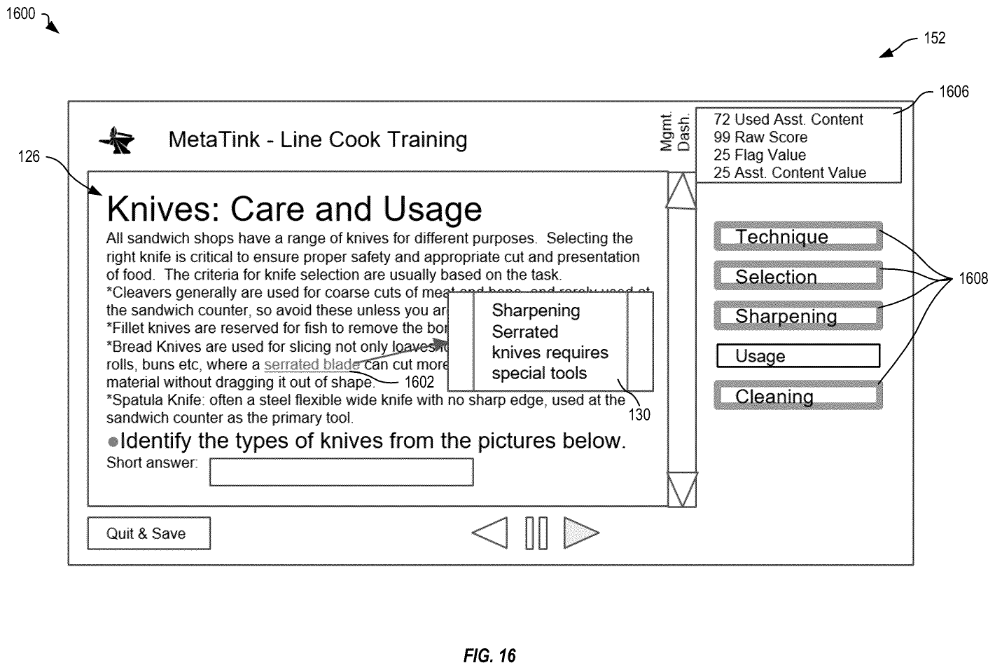

FIGS. 14 and 15 follow the example of FIGS. 6, 7, 10, and 11, where learner 160 is an advanced learner. Learner 160 has selected hyperlink 1402 causing display of assistive content 130 to learn about safety, since this was unknown to learner 160. Accordingly, interaction graph 1502 identifies gaps in knowledge of learner 160 and measures a skill level of learner 160. Learner 160 further completes all decision point 132 of content 126(6) without requesting any significant quantity of assistive content 130. Accordingly, analytical information 1006 and corresponding path directive 112 causes adaptive content engine 108 to select content 126(9) at high-skill level 202(m) to follow content 126(6). Screenshot 1400 also shows analytical information 1406 and assistive content buttons 1408 that allow learner 160 to displays more detailed assistive content 130. Particularly, as shown in FIG. 14, content 126 has less introductory content, as compared to content 126 of content 126(7) as shown in FIG. 16, and thereby provides an innovative immersive and adaptive experience for advanced learner 160.

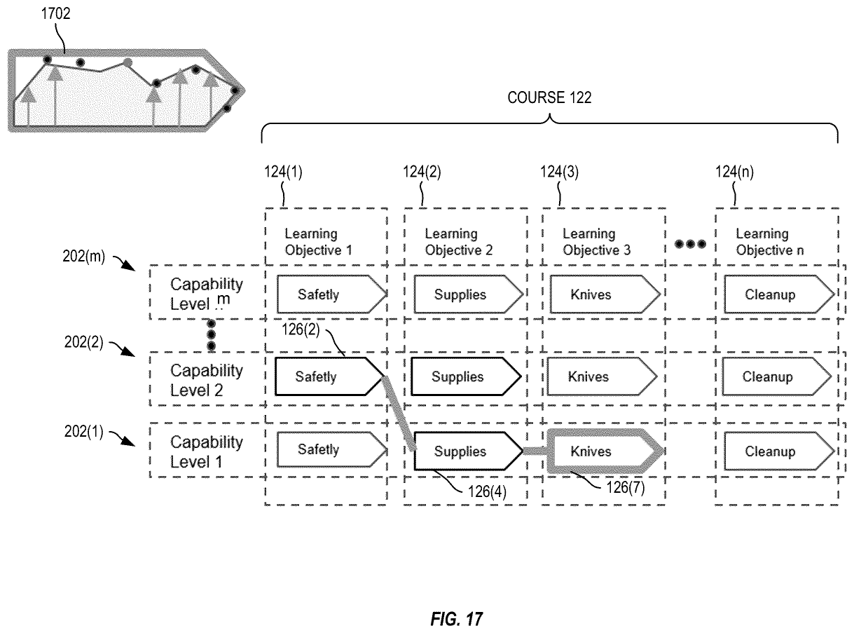

FIGS. 16 and 17 follow the example of FIGS. 8, 9, 12 and 14, where learner 160 is a novice learner. Learner 160 has selected hyperlink 1602 causing display of assistive content 130 to learn about sharpening a serrated blade, since this was unknown to learner 160. Accordingly, interaction graph 1702 identifies gaps in knowledge of learner 160 and measures a skill level of learner 160. Since learner 160 completed all decision point 132 of content 126(4), but only after requesting a significant quantity of assistive content 130, analytical information 1606 and corresponding path directive 112 causes adaptive content engine 108 to select content 126(7) at low-skill level 202(1) to follow content 126(2). Particularly, as shown in FIG. 16, content 126 has more introductory content, as compared to content 126 of content 126(9) as shown in of FIG. 14, and thereby provides a more complete immersive and adaptive experience for novice learner 160. Screenshot 1600 also shows analytical information 1606 and assistive content buttons 1608 that allow learner 160 to displays more detailed assistive content 130.

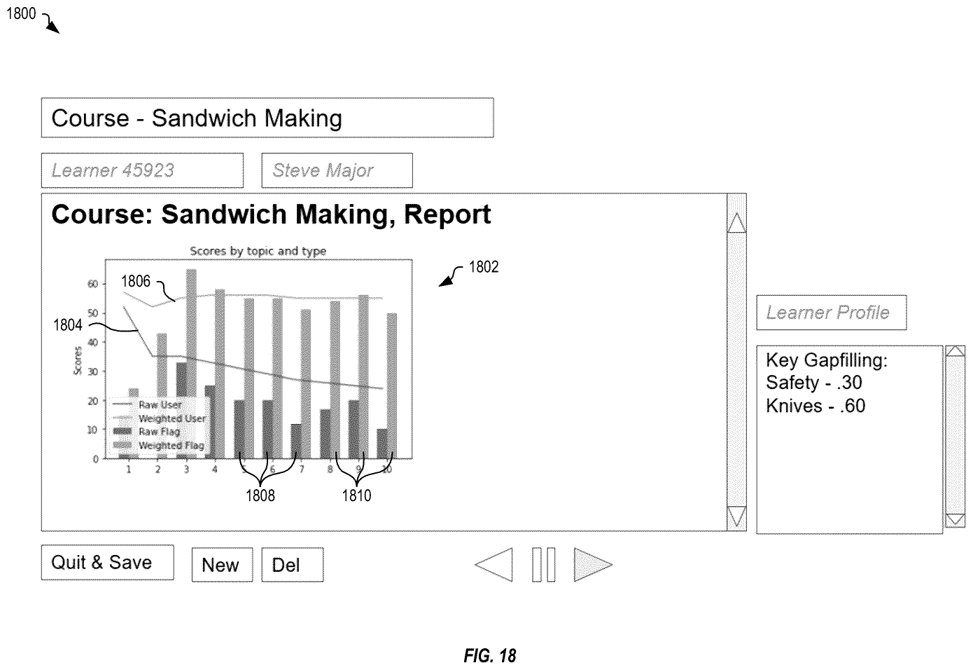

FIG. 18 shows one example report 1800 of progress made by learner 160 through course 122, in embodiments. Report 1800 includes a graph 1802 that shows captured results of learner 160 after course 122 is completed. In this example, graph 1802 shows a raw learner line 1804 generated from raw learner data in columns 1808 and a weighted learner line 1806 generated from weighted learner data in columns 1810. Raw flags and weighted flags are a significant part of the functionality of how adaptive content engine 108 is implemented. For further details of how report 1800 is generated, see the example equations in the section titled “An Example Implementation” below.

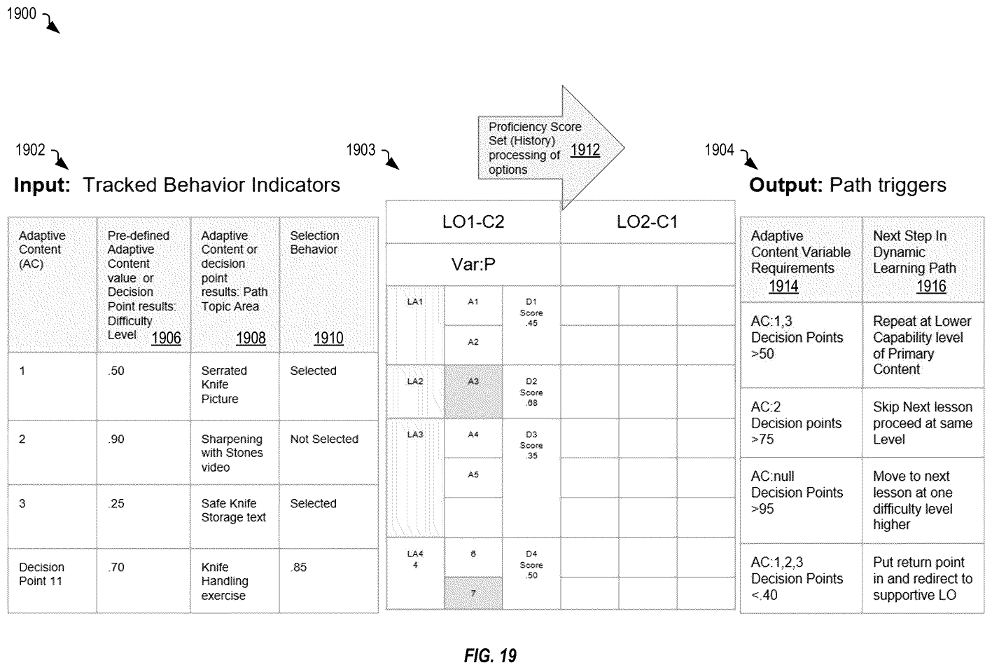

FIG. 19 is a data table 1900 illustrating example internal functionality of the adaptive content engine of FIG. 1 to track interaction of learner 160 with content 126 of course 122 to determine path directive 112, in embodiments. FIGS. 4 and 19 are best viewed together with the following description.

Data table 1900 has an input portion 1902 (Tracked Behavior), a learning objective table 1903, and an output portion 1904 (Path Triggers). Input portion 1902 shows example data used to track interactive behavior of learner 160 with content 126 and shows, for each of three different assistive content 130, a column defining a difficulty level 1906, a column defining a path topic area 1908, and a column defining a detected selection behavior 1910. The difficulty level may be defined by a designer of course 122, for example. Collectively, output portion 1904 forms a proficiency score set 1912.

Learning objective table 1903 shows example learning activities of content 126 and achievements of learner 160. Output portion 1904 shows example output path triggers used by adaptive content engine 108 to control the learning path based on proficiency score set 1912 (e.g., the detected interactive behavior), and includes a column defining requirements 1914 for each of the three different assistive content 130, and a column defining a next step 1916 in the dynamic learning path. Proficiency score set 1912 is an aggregate of the results of the decision point as modified by the assistive content and learner's historical proficiency scores in different topics.

Adaptive content engine 108 uses input portion 1902 and output portion 1904 to determine next step 1916 based on proficiency score set 1912. That is, regardless of capability level learner 160 must pass to move forward, and the next level of capability learning objective will be based on the full history of learner 160. Learner 160 may start at any capability level and the capability level may be automatically adjusted. Where learner 160 had a decision point that redirected to a separate Learning Objective, the current objective is saved as a return point, such that learner 160 may resume the current course once the remedial work is completed.

In the example of FIG. 19, learner 160 selected assistive content 1 and 3 and also passed the decision point 11, but the next step indicates repeating the same content at a lower skill level.

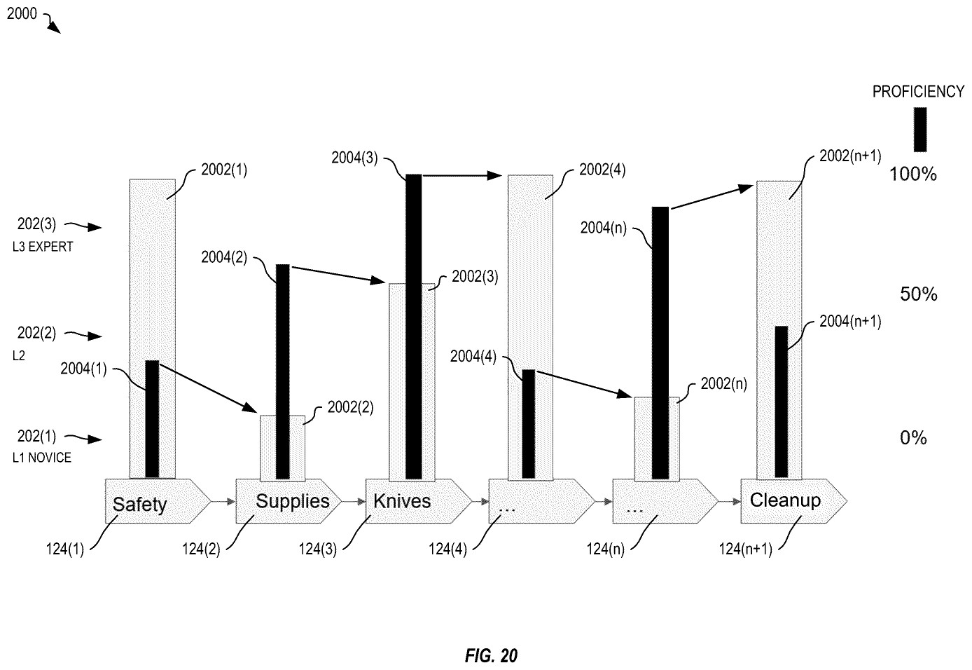

FIG. 20 shows one example graph 2000 illustrating larger scale adaptation between learning objectives 124 of course 122 of FIG. 1 for learner 160, in embodiments. For each learning objective 124(1)-124(n+1), graph 2000 shows a capability-level 2002(1)-2002(n+1) indicative of a skill level of the content 126 provided to (e.g., viewed by) learner 160 and a proficiency 2004(1)-2004(n+1) achieved by learner 160 for that content. In this example, content 126 of learning objective 124(1) was provided at high-skill level 202(3) but learner 160 attained a low proficiency level 2004(1) (e.g., 25%). Accordingly, path directive 112 determined a direction for the learning path to provide content 126 of learning objective 124(2) at low-skill level 202(1), as indicated by capability-level 2002(2). Learner 160 achieved a higher proficiency level (e.g., 57%) for learning objective 124(2) and path directive 112 steered the learning path to present content 126 of learning objective 124(3) at average-skill level 202(2) as indicated by capability-level 2002(3). Learner 160 achieved a high proficiency level 2004(3) for learning objective 124(3) and path directive 112 steered the learning path to present content 126 of learning objective 124(4) at high-skill level 202(3) as indicated by as indicated by capability-level 2002(4), and so on. Accordingly, the path through course 122 is dynamically selected by adaptive content engine 108 by determining path directive 112 at each decision point 132. This facilitates a multi-path opportunity for learner 160 along the learning path through learning objectives 124 (that have different capabilities levels) as the learning path is continuously generated in real time.

In this example, the level of capability of objective 124(2) (e.g., Supplies) is based on a proficiency level of learner 160 completing learning objective 124(1) and other proficiency/capability level history. The selected capability level is not based only on the immediately preceding learning objective results, but is based on the related aggregate for learner 160 as relevant to course 122, which may be defined by the course designer. For example, where minimum prerequisites are not met for objective 124(3) (e.g., knives), path directive 112 may provide a directive to an alternate path of lower prerequisite capability level. For example, adaptive content engine 108 may determine path directive 112 based on the LO capability level, the Student Proficiency Level in that LO, and the student proficiency level is the combination of their reception of optional learning content and their decision point results. The course designer may add triggers for other learning objectives. For example:

$$Capability level = Σ ( results ( previous novice level ) )$$

In this example, the learning outcome is making the sandwich. It should be noted that there is no difference in the required learning objectives demonstrated, such that each level of proficiency is demonstrated when learner 160 moves on to a next level.

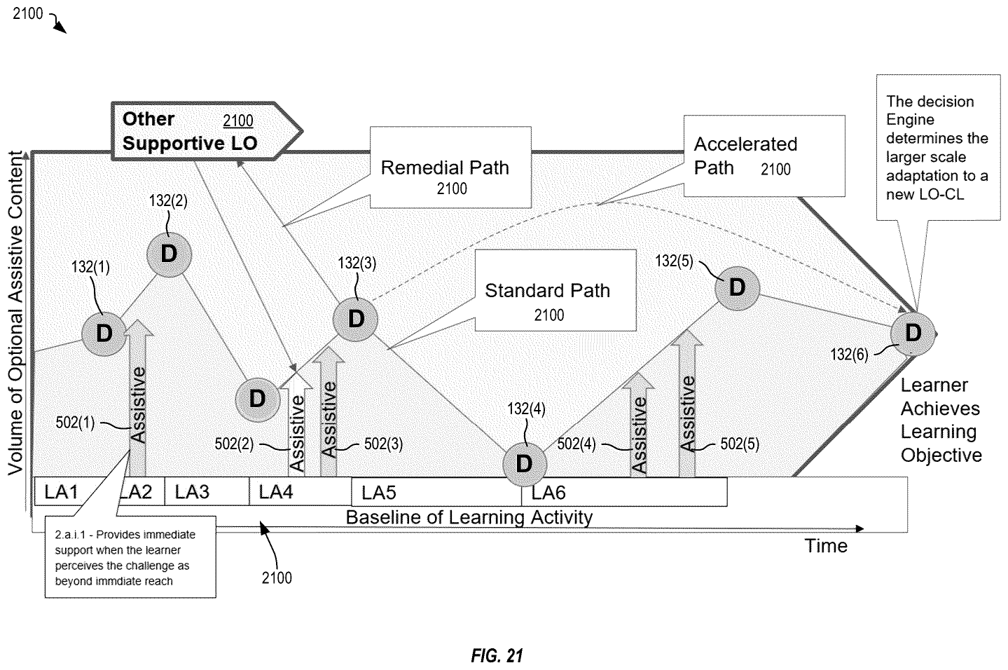

FIG. 21 is an interaction graph 2100 further illustrating progress of learner 160 through learning activities of content 126, in embodiments. Graph 2100 is similar to interaction graph 500 of FIG. 5 and shows arrows 502 indicative of assistive content 130 used by learner 160 and where learner 160 proficiency is assessed at decision points 132 within content 126.

Even prior to adaptive content engine 108 generating path directive 112, content 126 of learning objective 124 is inherently adaptive since assistive content 130 is optionally available and tracked as part of a perceived need for assistance of learner 160. Each decision point 132 represents a static decision point in course 122. Arrows 502 represent optional use of assistive content 130 by learner 160. Learner 160 may actively choose assistive content 130, and/or assistive content 130 may be prescribed proactively adaptive content engine 108 based on earlier behavior of learner 160 and/or other factors. For example, where learner 160 has a proficiency level indicative of a low success rate, assistive content 130 may be proactively pushed within content 126. Advantageously, by tracking perceived need for assistance, learning environment 100 presents content 126 at a most appropriate level and provides assistance where the need is perceived. Path directive 112 selects one of an accelerated, standard, and remedial path at each decision point 132 as may be defined by the designer of course 122 and based on the proficiency of learner 160 in each topic in their history. For example, arrow 502(2) (yellow) indicates assistive content 130 that is pushed by adaptive content engine 108, while arrows 502(1), 502(3)-(5) (e.g., green) represents assistive content 130 that is optionally available for selection by learner 160.

Advantageously, as compared to standard assessment techniques of the prior art, adaptive content engine 108 achieves the learning objective with a radically different approach that uses a measure of assistive technology to support the learning experience rather than a punitive assessment of results.

### Multiple Scales of Adaptation: 1—Within the Learning Object

Tracking the selection of assistive content 130 as an indicator of a perceived proficiency of learner 160 enables adaptive content engine 108 to adjust the capability level of content 126 in real-time based on the learner's request for the assistive content. Adaptive content engine 108 provides immediate support when the learner perceives the challenge as beyond immediate reach. Adaptive content engine 108 diverts the learning path at each decision point 132 based on use of assistive content 130 and completion success level for any single learning objective 124.

### Multiple Scales of Adaptation: 2—Between Learning Objects

Upon Completing learning objective 124, adaptive content engine 108 may use the following to select the next learning object: determines whether the learner has been successful in the learning object at the capability level, determines whether the learner needs a lower or higher capability level of the same object. When adaptive content engine 108 determines that the learner has successfully completed the learning object, adaptive content engine 108 determines a next object on the learning path at the appropriate capability level based on the learner history from related topics.

### Pedagogical Uniqueness

Advantageously, adaptive content engine 108 automatically selects an appropriate level of content 126 based on leaner exploration of assistive content 130 prior to completing challenges within the decision points. Adaptive content engine 108 monitors and adapts the learning path to address both identified skill gaps and pre-existing proficiencies related to learning objectives.

This approach moves away from the “Least Common Denominator” approach to learning and provides a learning experience tuned to challenge the learner at the appropriate capability level and pace.

### An Example Implementation

The following provides an algorithmic example for using learner-selected optional assistive content to determine the learning path forward for the learner.

### Relevant Learner Elements:

Topic History (topic1:rawscore1:proficiency1, . . . topicN:rawscoreN:proficiencyN)
Activity History (activity1:date1:rawscore1:proficiency1, . . . activityN:rawscoreN:proficiencyN)

Topic History is a data array that defines a proficiency score of the learner that is updated when each learning activity (activity) is completed. Topic History is used for determining challenge modifiers for subsequent activities. Activity History is a data array that defines

Elements that May Inform the Decision Point:
Topics (topic1, topic2, topic3, . . . topicN)

Topics are the primary areas of knowledge assessed at each decision point. Learners have proficiency ratings in each topic based on previous performance or self-assessment.
Predecessors (predecessor1, predecessor2, . . . predecessorN)

Predecessors are decision points that are assessed before the current decision point may be assessed by learning environment 100. Learning environment 100 checks the learner activity history to ensure the learner has sufficient proficiency before presenting the activity. Learning environment 100 uses predecessors for sequencing activities within a learning objective. Note that learning environment 100 may simulate a learner's performance in any given activity, based on sufficient historical learner proficiency data.

Assistive content (a) for each challenge is a dictionary of assistive content identifiers (aid) and associated point values.

$$a = \{ aid 1 : value 1 , aid 2 : value 2 , … aidN : valueN \}$$

Assistive content is provided automatically to reduce the challenge rating to the learner's proficiency level+1. Learners may receive additional assistive content if necessary, and any assistive content taken reduces the raw score by the value of the assistive content. In more complex implementations, Assistive Content values may be allocated by topic, and so can have more relevant impacts on learner proficiency scores. In this case:

$$a = \{ aid 1 : \{ topic 1 : value 1 , topic 2 : value 2 , … topicN : valueN \} , \\ … aidN : \{ topic 1 : value 1 , topic 2 : value 2 , … topicN : valueN \} \}$$

Point Value (V) is the total value of the activity, defined by the content developer. Note that assistive content point values are proportional to the total point value for proficiency calculations to be meaningful. That is, the sum of assistive content values in H for a given activity is less than or equal to V, the total point value for that activity.

Choosing the next Learning Activity in the Learning Objective

### “Accelerated” Pathing:

If the learner is (a) at Y % (e.g. 90%) or above proficiency for all topics associated with the next activity supporting the current learning objective, or (b) the average proficiency for all topics is at or above Z % (e.g., 95%), the next activity may be automatically skipped, or the learner may be asked if they wish to attempt the activity as a review.

$$min ( P ) \geq Y \%$$

Average Proficiency (P) for n topics relevant to the learning activity calculated by:

$${P}_{avg} = \frac{{\sum }_{1}^{n} ( {P}_{i} )}{n}$$

### “Standard” (as Designed) Path:

If the learner (a) is at less than Y % (e.g. 90%) but greater than X % (e.g. 35%) proficiency for topics associated with the next Learning Activity (activity) supporting the current Learning Objective (objective), or (b) has sufficient proficiency history recorded by learning environment 100, the learner proceeds to the next activity. For example, when a learner has completed fewer than five learning activities with the relevant topic within the past six months, the recorded proficiency history may be deemed insufficient.

$$X \% \leq min ( P ) < Y \% \\ AND \\ {P}_{avg} < Z \%$$

“Remedial” (Decelerated) pathing:

If the learner is at or below X % (e.g. 35%) in a percentage (defined by the content developer or learning manager) of the topics associated with the next learning activity, the learner may be redirected to different learning objectives with the intent to elevate their topic proficiencies to a level that will allow them to complete the standard path, or at a minimum the next learning activity, in the current learning objective. The learner may then be returned to the learning activity for which they did not previously meet the prerequisite proficiency level.

$$min ( P ) < X \%$$

### Choosing the Next Learning Objective to Achieve the Learning Outcome

At the end of the learning objective, aggregate raw and proficiency scores matched against thresholds set by the instructional designer or learning manager inform whether the learner must repeat the learning objective or may move on to other objectives.

The decision point within each learning activity is nearly identical with the decision point at the end of the learning objective to select the path to the next learning objective. The primary difference is that subsequent learning objectives may be selected by the learner (e.g. based on personal interest), the Learning Manager (e.g. based on organizational requirements), or by learning environment 100 itself (e.g. based on inferred student interest calculated from learner interactions with learning environment 100, and knowledge of paths taken by learners with similar history and proficiencies.

“Accelerated” pathing skip next learning Objective and move on to next one where work is needed based on topical performance history. “Standard” pathing moves to the next Learning Objective at a level based on the history of proficiency in related topics. “Remedial” pathing cover the same Learning Objective at a lower capability level (where more assistive content is exposed automatically, offering a more content-rich experience for those needing more assistive content).

### Calculating Learning Activity Raw Score (SR)

Each activity is assigned a point value (V). The raw score (SR) is calculated by subtracting the value of each assistive content provided (a0 . . . aN) to the learner (either automatically to adjust the challenge rating, or on demand to aid in completion) from (V), and then dividing by the full activity value (V)

$${V}_{o} = V - {\sum }_{1}^{n} ( {a}_{i} ) \\ SR = \frac{V - {V}_{o}}{V}$$

### Calculating the Learning Activity Proficiency Score (SP)

The proficiency score is weighted, based on the learner's current proficiency rating for the topics associated with the challenge, and is intended to indicate the learner's ability to perform the challenge after they have completed it. Essentially, if a challenge is deemed more challenging for an individual, i.e. a significant amount of assistive content is provided automatically, a coefficient will be applied to assistive content points taken to reduce the impact on the final proficiency score. The challenge adjustment (C) is calculated by averaging the learner's proficiency scores (P) for all topics represented in the activity and subtracting from one. Since (P) is always 0≤P≤1, 0≤C≤1. A higher proficiency will result in a lower challenge modifier.

$$C = 1 - \frac{{\sum }_{1}^{n} ( {P}_{i} )}{n} \\ SP = \frac{V - C \cdot {V}_{o}}{V}$$

A more complex implementation may allow content designers to assign weights to topics for each learning activity, which could be factored into raw and proficiency scores.

### Updating the Learner Raw and Proficiency Scores:

# pull the learner's current stats for this topic.
c − learner[‘topics’][i][“count”]
r − learner[‘topics’][i][“raw”]
w − learner[‘topics’][i][“weighted”]
# update the learner's stats based in update formulas.
learner[‘topics’][i][“raw”] = ((r * c) + raw) / (c + 1)
learner[‘topics’][i][“weighted”] = ((w * c) + weighted) / (c + 1)
learner[‘topics’][i][“count”] += 1

### Choosing the Initial Difficulty (D) of the Learning Activity:

The exercise Difficulty rating is moderated by providing additional guidance in the form of assistive contents. The Difficulty rating for an activity is calculated by taking the challenge adjustment, adding the value of assistive content in sequence until the target score is reached, and then subtracting one assistive content. Removing assistive content provides an opportunity for the learner to incrementally advance in proficiency levels.

Below is a python code snippet for calculating what assistive content to include for a particular activity, based on challenge ratings for an individual.

# Learning Activity Elements
A = { “a1”: 10, “a2”:10, “a3”:10, “a4”:10, “a5”:10, “a6”:10,
“a7”:10, “a8”:10, “a9”:10, “a10”:10} # simplified sample
assistive content dict

| | |
|---|---|
| C = [1, .9, .75, .5, .25, 0] | # some sample challenge ratings |
| V = 100 | # full point value for the learning |

activity
for c in C:
print(“Running calculations for { }”.format(c))

| | |
|---|---|
| t = c*V | # target point value |
| s = V | # set the starting point value for calculations |
| a = 0 | # cumulative assistive content value |
| i = 1 | # start at the first assistive content |
| j = “” | # init the last included assistive content value |

```
  for ac,value in A.items( ):
    if s − value <= t:
      break
    else:
      s = s − value
      a = a + value
      j = ac
      print(“ target value: { }, current value: { }, current ac:
{ }, cumulative ac value: { }”.format(t,s,ac,a))
  print(“ s = { }, t = { }, will include assistive content through
{ }”.format(s,t,j))
```

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for adapting a learning path of a learner through a course, comprising:
detecting behavior of the learner selecting, via interaction with a client device, assistive content during interaction with first content, of a first learning requirement of the course, displayed in a user interface on the client device;
determining a proficiency of the learner at a decision point of the first learning requirement;
determining a path directive based on the behavior, the proficiency, and a learner history, the path directive defining a direction of a next step in the learning path for the learner;
determining a next content and a next skill level based on the path directive; and
presenting the next content at the next skill level to the learner.

2. The method of claim 1, the next content being content of the first learning requirement and the next skill level being lower than the first skill level.

3. The method of claim 1, the first content comprising both primary content displayed within the user interface and assistive content not displayed within the user interface until interactively invoked by the learner.

4. The method of claim 1, the next content being content of an immediately subsequent learning requirement of the course.

5. The method of claim 1, wherein the next skill level is higher than the first skill level when the proficiency indicates a skill level above the first skill level, the next skill level is lower than the first skill level when the proficiency indicates a skill level below the first skill level, and the next skill level is the first skill level when the proficiency indicates a skill level similar to the first skill level.

6. The method of claim 1, the next content being content of a subsequent, but not immediately subsequent, learning requirement of the course when the proficiency indicates topics of an immediately subsequent learning requirement of the course is already known by the learner.

7. The method of claim 1, the next content being for a topic external to the course when the learner exhibits low proficiency in the topic.

8. The method of claim 1, the learner history comprising stored proficiency of the learner over time.

9. The method of claim 1, the detecting behavior comprising detecting one or more of: (a) selection of a link within the content to display first assistive content, (b) a mouse pointer hovering over a particular area of the content to display second assistive content, and (c) other digital means of selecting assistive content.

10. The method of claim 9, the first assistive content and the second assistive content each comprising one of hints, recaps, and definitions corresponding to the first content.

11. A learning environment for adapting a learning path of a learner through a course, comprising:
a processor;
a memory communicatively coupled with the processor and storing machine-readable instructions that, when executed by the processor, cause the processor to:
present first content, of a first learning requirement, to the learner at a first skill level within a user interface on a client device;
detect behavior of the learner selecting assistive content during interaction with the first content within the user interface;
determine a proficiency of the learner at a decision point of the first learning requirement;
determine a path directive based on the behavior, the proficiency, and a learner history, the path directive defining a direction of a next step in the learning path for the learner;
determine a next content and a next skill level based on the path directive; and
present the next content at the next skill level to the learner within the user interface.

12. The learning environment of claim 11, the next content being content of the first learning requirement and the next skill level being lower than the first skill level.

13. The learning environment of claim 11, the first content comprising primary content and assistive content that is hidden within the user interface until interactively invoked by the learner.

14. The learning environment of claim 11, the next content being content of an immediately subsequent learning requirement of the course.

15. The learning environment of claim 11, wherein the next skill level is higher than the first skill level when the proficiency indicates a skill level above the first skill level, the next skill level is lower than the first skill level when the proficiency indicates a skill level below the first skill level, and the next skill level is the first skill level when the proficiency indicates a skill level similar to the first skill level.

16. The learning environment of claim 11, the next content being content of a subsequent, but not immediately subsequent, learning requirement of the course when the proficiency indicates topics of an immediately subsequent learning requirement of the course is already known by the learner.

17. The learning environment of claim 11, the next content being for a topic external to the course when the learner exhibits low proficiency in the topic.

18. The learning environment of claim 11, the learner history comprising stored proficiency of the learner over time.

19. The learning environment of claim 11, the machine-readable instructions that detect behavior further comprising machine-readable instructions that detect one or more of: (a) selection of a link within the content to display first assistive content, (b) a mouse pointer hovering over a particular area of the content to display second assistive content, and (c) other digital means of selecting assistive content.

20. The learning environment of claim 19, the first assistive content and the second assistive content each comprising one of hints, recaps, and definitions corresponding to the first content.
